(19) United States
(12) Patent Application Publication
(10) Pub. No.: US 2009/0114422 A1
(43) Pub. Date: May 7, 2009

(54) Heizbares seil

(75) Inventor: Bruno Longatti, Stein (CH)

Correspondence Address: BIRCH STEWART KOLASCH & BIRCH, PO BOX 747, FALLS CHURCH, VA, 22040-0747, US

(73) Assignee: Fatzer AG Drahtseilwerk, Romanshom (CH)

(21) Appl. No.: 12/230,948

(22) Filed: Sep. 8, 2008

(30) Foreign Application Priority Data
Sep. 10, 2007 (CH) 1411/07

(51) Int. Cl. H01B 5/08

(52) U.S. Cl. 174/128.1

(57) ABSTRACT

A cable, which is especially suitable as a suspension cable for cable railways, is described. The cable comprises a core (31) and several outer strands that surround the core and consist, for example, of several wires (32.1 . . . 32.6, 34.1 . . . 34.12). The cable is characterized by an integrated antifreezing device (33.1 . . . 33.6) which can be controlled from one end of the cable, preferably to prevent or specifically remove ice formations on an outer side of the cable. The antifreezing device (33.1 . . . 33.6) is thereby preferably integrated in at least one of the outer strands, however, it can also be integrated in the area of the core (31) of the cable or in inserts that fill spaces between individual wires (32.1 . . . 32.6, 34.1 . . . 34.12) of the cable. As the antifreezing device (33.1 . . . 33.6) is preferably configured as resistance heating, its heat intensity can be accurately adjusted by the flow of the current. By means of the cross sections that can be changed along the cable or changeable material properties of the heating wires (33.1 . . . 33.6), it is possible to heat, especially intensely, in a concentrated manner, sections of the cable to be heated. In this way, the overall energy consumption of the device described can be as low as possible. Various constellations of strand wires (32.1 . . . 32.6, 34.1 . . . 34.12), of the core (31) of the cable and the antifreezing devices (33.1 . . . 33.6) can occur, from the integration of the antifreezing devices (33.1 . . . 33.6) in the core (31) of the cable to their positioning on parts of the outer surface of the cable.

### TECHNICAL FIELD

The invention relates to a cable, in particular a fixed cable for cable railways, cable structures and/or energy transfer, comprising a core and several outer strands surrounding the core.

### Prior Art

A cable consists of a plurality of (stranded) outer strands, such as for example wires or strands, which are wrapped about a core. Cables are flexible and are used for the transfer of tractive forces and/or electric energy. In addition to the tensile strength of the material and the size of the cross section, the cable structure (lay length ratio, etc.) can also be decisive for the tensile strength. In this connection, strands is understood to mean bundles consisting of several stranded wires or fibres.

Fixed cables, such as e.g. suspension cables for cable railways or cables as power transmission lines as used in high-voltage power lines or telephone lines, are partially subjected to powerful weather factors and, in particular, to the danger of icing. Ice formations of this type can result therein that the cable no longer functions properly and that the cable is no longer capable of reliable service. With power transmission lines, there is also often the problem that, depending on the weather, icing can occur which can result in an interruption of the connection and, in the worst case, destruction of the line, for example, due to poles breaking under the additional load of the ice formations.

FR 2 723 677 (Flosi) discloses an antifreezing device for cables in which a container with hot water is brought into contact with the cable to be heated. The container comprises a chamber with an antifreeze solution which is in contact with two electric conductors of different polarity. When a voltage is applied to the electrical conductor, a current flows through the antifreeze solution and heats it. The heat is transferred by the container to the part of the cable in contact with it. Containers of this type can thereby be arranged along the cable.

WO 97/03540 (MKS) describes a flexible insulated heating for a cable or tube. The heating thereby comprises two layers of glass- fibre reinforced plastic layers which are laminated together and have resistance heating wires between them. In this case, the heating is formed in such a way that it completely surrounds the periphery of the cable or tube to be heated. A thermal insulation, e.g. a polymer foam, is applied to the outer surface of the heating. This insulating layer reduces heat loss into the surroundings and forms a protection against combustion on the heating.

The solutions described in the prior art for heating a cable are not suitable for a suspension cable for cable railways because they must all be attached from the outside to the cable to be heated. According to its use, a suspension cable on which heavy loads are to roll cannot be equipped with antifreezing devices of this type. In addition, due to the relatively high mechanical demands such as watertightness and weatherproofing, the known solutions are prone to failure and they are maintenance intensive.

### DESCRIPTION OF THE INVENTION

The object of the invention is to create a cable relating to the above-noted technical field which is protected against ice formation and/or which can be selectively de-iced.

The solution of the object is defined by the features of claim 1. According to the invention, the cable comprises an integrated antifreezing device which can be activated from one end of the cable or by radiant energy locally coupled in a surface area of the cable.

An antifreezing device integrated in the cable enables the use of the cable as a suspension cable for cable railways since the outer area of the cable which is designed, for example, to guide the rollers of a cable railroad car is not affected by elements mounted on the cable. The cables according to the invention are also suitable for cable structure applications, e.g. for bridges, roof guy cables, facades or extensive functional structures. In addition, integrating the antifreezing device makes it largely unlikely that it is susceptible to outside influences, e.g. weather. Furthermore, an antifreezing device which can be controlled from one end of the cable or from both ends of the cable does not require any large-scale control mechanism along the cable. As an integrated antifreezing device, it is also extended over the entire length of the cable (or a part thereof). If, for example, the antifreezing device is designed as a heating wire, it can be activated by applying a current.

In an embodiment of the antifreezing device as an antifreeze discharger, the antifreezing device can be operated by controlling the flow of an antifreeze agent through the antifreeze discharger.

In addition to its use in a suspension cable for cable railways, the antifreezing device according to the invention can also be used, for example, in suspension cables or hauling cables for a different use or in high-voltage or telephone cables or in other transmission lines.

It is also possible to integrate a radiation-absorbing layer of wire, in particular of aluminum, in the cable as an antifreeze element which can be inductively heated. The material for the radiation-absorbing wire layer usually differs from the material which is used for the remaining cable components. In this way, electromagnetic radiant energy can be locally coupled in specific areas of the cable and subsequently converted into heat in the radiation-absorbing wire layer. This embodiment is of particular interest in cable railroad cables as the required radiation source can be situated, for example, on a cable railroad car. Thus, ice which has formed on the cable can be locally melted by inductive heating and immediately thereafter be completely pushed away by the wheels of the cable car. In steel cables, the radiation-absorbing wire layer is preferably integrated in the outermost outer layer of the cable to reduce radiation losses.

Furthermore, a microwave-absorbing material can be integrated as antifreeze element. Silicone, urethane or neoprene based materials are especially suitable. For example, these can be present in the form of thick foils about inner cable layers or as solid cylindrical inserts between the strands of the cable. In this case also, an arrangement in the outermost outer layer of the cable is preferable when integrated in steel cables so as to prevent reflection losses of the microwaves as much as possible. However, it is also possible to integrate the microwave-absorbing materials as antifreeze elements in the inner regions of the cable and to conduct the microwave radiation from one end of the cable through a microwave conductor installed in the cable to the microwave-absorbing materials. For example, waveguides having a round and, in particular, rectangular hollow section are suitable as microwave conductors.

Materials having a high absorption property for infrared radiation can also be provided as antifreeze elements. In particular, organic polymer compounds, e.g. polyurethanes or polyamides, are suitable for this.

It is also within the scope of the invention to provide liquids as microwave-absorbing material or for the absorption of infrared radiation which, for example, are present in a hose integrated in the cable. To prevent the liquids from freezing, liquids having freezing points clearly below the freezing point of water are preferably used. For example, solutions consisting of water with antifreeze agents such as glycerin, glycol or ethanol are suitable.

Preferably, the antifreezing device comprises an antifreeze element integrated in one of the outer strands. In this way, a direct effect on the surface (or outer surface) of the cable can be obtained. Several outer strands can also be provided with an antifreeze element.

The outer strands are preferably configured as strands which can be composed of several wires and of wires of different gauges. The antifreezing devices can then be arranged as a part of the outer strand or outside of the outer strand in the outer area of the cable (but, as before, inside the encasing curve, in particular of the enveloping circle of the cable cross section).

In another preferred embodiment, an antifreeze element is integrated in the core of the cable. The core is thereby made, for example, of plastic or steel and is surrounded e.g. by six outer strands in a known manner. A positioning of the antifreeze element in the core of the cable has the advantage that the heat generated by the antifreezing device is transferred uniformly over the outer strand to the outer regions of the cable. A heat distribution which is essentially homogeneous over the surface of the cable is produced. In addition, the antifreeze element in the core is better insulated against undesirable environmental influences. The radial compressive load of the cable, as occurs in the case of a suspension cable of a suspension railway, barely has an effect on the heating element.

The outer strands do not have to be designed as strands, but can, as in a cable, be formed as individual wires or individual filaments arranged in layers. Several layers of outer strands can be provided.

Advantageously, the cable has plastic inserts between the cable elements, in particular between the outer strands and the core or between adjacent outer strands. Preferably, an antifreeze element is integrated in at least one of the inserts. Inserts of this type can improve the life and stability of the cable. Preferably, they thereby form a type of support for individual cable elements and can protect the inner regions of the cable against outside influences, such as for example penetration of water and dirt.

Alternatively, antifreeze elements can also be integrated in various spaces, as can be present e.g. between individual outer strands or between outer strands and core.

The antifreezing device advantageously comprises an electrically conductive wire which can be used instead of a steel wire or filament of an outer strand. As it is e.g. made of copper and thus less tension-proof as, for example, a steel wire, this can change the load capacity of the outer strands. If this is to be excluded, the electric wire should not be integrated in the cable instead of but in addition to the supporting wires of the strands. The antifreezing device does not, preferably, replace any elements of the cable which contribute to the stability, e.g. tensile strength or breaking strength of the cable, but is integrated in the strand in addition thereto.

The antifreeze element can be designed as a wire mesh (for example, on a surface of at least one of the inserts or in the core). A wire mesh of this type can be adapted to the spatial form of the cable element and enables an areal heating. The wire mesh can also be integrated in the inserts. Thus, it can be led precisely inside the cable. The wire mesh is thereby preferably led in such a way that, although it has as high an efficiency as possible for the de- icing, it is optimally protected against mechanical loads. With inserts consisting of electrically insulated material, the wire mesh is also automatically electrically insulated against its environment. Depending on the arrangement of the inserts, it is advantageous if the wire mesh extends only on the surface of an insert, on the surfaces of several inserts and/or within the inserts.

Instead of wire meshes, plate-like surface heating elements can also be used which can, like the wire meshes, be wound e.g. between two cable layers about the inner layer of the two cable layers. Surface heating elements of this type can be provided along the entire length of the cable. However, it is also possible to only attach the surface heating elements in the form of plate-like strips or rings to the especially endangered points of the cable.

Alternatively, the wire mesh can also extend on other surfaces; thus, for example, it can extend along individual wires, on the surface of the core of the cable or on the outer surface of the cable. It should thereby be noted that the wire mesh becomes worn or mechanically strained in the normal use of the cable.

It is possible that the inserts have differently formed sections, in particular sections of different heat conductivity. The inserts can, for example, have different sections along the orientation of the cable. The different designs of the inserts of the cable can thereby be of a spatial nature, i.e. especially a change of the volume filled by inserts. For example, this can result in a wire mesh extending on the inserts or an antifreezing device integrated in the inserts are alternately led up to the surface of the cable and away from it. At points of the cable at which the antifreeze element extends on the surface of the cable, an efficient heating performance with respect to the surface of the cable is to be expected. Sections of different heat conductivity enable a precise control of the heat flow inside the cable and along the cable. In those areas in which the inserts have a greater heat conductivity, the heat generated by the antifreezing devices reaches e.g. the surface of the cable more easily, quicker and with less loss. In those areas which have less heat conductivity, the heat is transferred less efficiently. In this way, the heat generated by the antifreezing device can be concentrated and applied to especially efficient or frost-endangered points. A periodic arrangement of areas with inserts of specific heat conductivity can also be realized in this way. When using heating elements led in the inserts, a distribution of the temperature in the cable and thus on its surface can be defined, for example, by areas of different heat conductivity of the inserts. The temperature distribution can thereby be related to both the longitudinal direction of the cable and to individual angular areas of the cable.

Alternatively, the cable can also have inserts which are the same along the entire cable. In addition, inserts can also be omitted. Preferably, the antifreezing device is in the form of an electrical resistance heating. Preferably, this can be an electrically conductive wire with a defined electrical resistance. When current flows through the wire, it heats up and emits heat to its surroundings. An embodiment of the antifreezing device of this type is especially low in maintenance and can be easily integrated in the cable. In addition to a single wire, a wire bundle, a wire mesh or several spaced individual wires can, for example, be provided.

Instead of or in addition to a resistance heating, other antifreezing devices, such as antifreeze agents or mechanical devices (e.g. ultrasound elements) are also feasible for removing ice on the cable.

Preferably, an antifreezing device which functions as resistance heating has sections of different electrical resistance. Thus, it can be provided that a greater heating effect occurs at specific areas than at others, for example along the cable. Preferably, the antifreeze element comprises such areas with higher electrical resistance than other areas of the antifreeze element. With a constant flow of current through the antifreezing device, more heat is generated in the areas of greater electrical resistance than in those areas of less electrical resistance where the current is led through at a lower voltage drop and, accordingly, generates less heat. Consequently, from a functional point of view, the antifreezing device can be divided into a heater and a conductor. The heater can relate to a short cable section in relation to the length of the conductor. This concept results in a saving of required heating performance and enables a concentration of the heat at especially important, e.g. at especially exposed, points of the cable. The areas of high and low electrical conductivity or the areas of low and high electrical resistance can be realized, for example, by selecting different cross sections of the wire or wires or by selecting different materials. In addition to sections of different electrical resistance arranged along the cable, the cable can also have antifreeze elements of varying resistance in radial direction. This can be accomplished, for example, by heating elements positioned at various radial distances from the centre of the cable, through which currents of different strengths flow or which have resistances of various magnitudes. Thus, for example, it can be ensured that the cable has a temperature distribution that is largely homogeneous over its radius, which can be significant e.g. for strain within the cable and thus e.g. for the long life of the cable.

Alternatively, the antifreezing device can also be formed, for example, by a wire or several wires which have a constant electrical resistance over its length.

It is also within the scope of the invention to design the antifreezing device as an antifreeze discharger. For example, this can be a line integrated in the cable through which antifreeze is obtained on the outer surface of the cable at specific locations. Preferably, the line is integrated in the outer part of the cable, in particular in the outer part of the inserts, which is not under the radial pressure of the outer strands. Moreover, it is advantageous if the points of discharge for the antifreeze directly adjoin the outer surface of the cable. In this case, the discharge points of the line can be formed by holes in the line. It is understood that, when selecting the antifreeze, care should be taken that it is compatible with the cable lubricant.

As already mentioned above, the antifreeze is usually only provided in selected sections of the cable. In this way, an energy efficient de-icing can also be made possible in cables having a length of e.g. several hundred meters. First of all, the antifreezing device should be effective at those points which are especially prone to frost or freezing. For example, points of the cable that are particularly exposed to weather can be considered with an especially high concentration of the antifreeze action, while there can also be other points of the cable which are also protected against freezing and the like due to the effect of the antifreezing device at adjacent points. It is thereby also conceivable that the antifreezing device is used, on the one hand, on selected sections of the cable and, on the other hand, at selected times or over selected periods.

Alternatively or in addition, the cable can also be provided with the antifreezing device over its entire length.

Furthermore, it can also be advantageous to provide heat-insulating elements inside the cable which divide the cable, in particular in radial direction, into an inner and an outer area. As a result, it is obtained that the heat which is generated by the antifreeze elements reaches the respective other area of the cable less effectively or that the entire cable is not heated. Advantageously, the antifreezing device is situated in the outer area, outside of the heat-insulating elements. Consequently, the heating energy can be specifically concentrated on the critical outer area during de-icing, which reduces energy consumption. Heat-insulating elements can, in principle, be made from all materials that exhibit an insulating effect with respect to heat. Plastics or fibrous materials are, for example, suitable for this. Expanded plastics, such as polystyrol, neopor or polyurethane, for example, have proven to be especially suitable. However, mineral, glass wool or foam glass are also suitable as materials for heat- insulating elements. The heat-insulating elements are preferably attached in those areas of the cable in which there are also antifreezing devices.

Further advantageous embodiments and combinations of features of the invention can be found in the following detailed description and the patent claims in their entirety.

### BRIEF DESCRIPTION OF THE DRAWINGS

The drawings used to explain the embodiment show:

FIG. 1 a cable in cross section with antifreezing devices on the outside;

FIG. 2 a cable in cross section with multiwire outer strands;

FIG. 3 a cable in cross section with two layers of outer strands;

FIG. 4 a cable in cross section with antifreezing devices located inside the cable;

FIG. 5 a cable in cross section with antifreezing devices located in the core of the cable;

FIG. 6 a cable in cross section with inserts and antifreezing devices on the surface thereof;

FIG. 7 a cable in cross section with antifreezing dischargers located in the inserts;

FIG. 8 a cable in cross section with a wire of a strand replaced by an antifreeze element; and

FIG. 9 a cable in longitudinal section with resistance heating element and current supply in sections;

FIG. 10 a cable in longitudinal section with an externally closed circuit;

FIG. 11 a cross section of a suspension cable according to the invention having three wires replaced by an antifreeze element;

FIG. 12 a variant of the suspension cable of FIG. 11 having an antifreeze element in the core;

FIG. 13 a variant of the suspension cable of FIG. 11 having an antifreeze element in a profiled wire situated on the outside;

FIG. 14 a variant of the suspension cable of FIG. 11 having a wire mesh as antifreeze element between the outermost two layers consisting of profiled wires.

FIG. 15 a variant of the suspension cable of FIG. 14 having an additional insulating element inside the cable.

Basically, the same parts in the figures are provided with the same reference symbols.

### METHODS FOR CARRYING OUT THE INVENTION

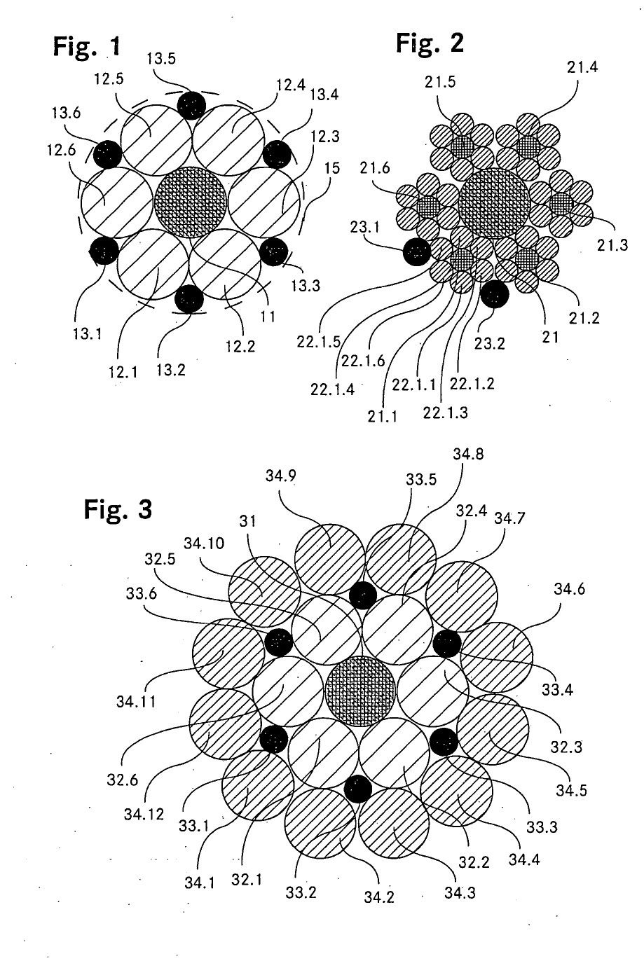

FIG. 1 shows a basic illustration of a preferred embodiment of a cable in cross section. The cable, shown in a simplied manner, comprises a core 11 and six strands 12.1 . . . 12.6 adjoining the core and evenly arranged about the core which can be formed of individual wires or as strands consisting of several wires. The strands 12.1 . . . 12.6 have about the same diameter as the core 11, so that they essentially lie on the core 11 and come in contact with the adjacent strands 12.2, 12.6 . . . 12.5. 12.1. A total of six antifreeze elements 13.1 . . . 13.6 are attached in the area of the outer periphery 15 of the cable between the adjacent strands 12.1 . . . 12.6. The antifreeze elements 13.1...13.6 are thereby partially situated in the spaces between adjacent strands 12.6, 12.2 . . . 12.5, 12.1 and contact two strands 12.6, 12.2 . . . 12.5, 12.1 each. The antifreeze elements 13.1 . . . 13.6 are arranged in such a way that they are inside and, preferably, at a distance from the periphery 15 which encases core 11 and strands 12.1 . . . 12.6. No part of the antifreeze elements 13.1 . . . 13.6 should protrude beyond the periphery.

The cross section of an antifreeze element 13.1 . . . 13.6 can definitely be relatively small (i.e. smaller than schematically shown in FIG. 1) in relation to the space which is formed between the adjacent strands and the periphery. Thus, the cross section can be e.g. within an area which is defined by an outer tangent on adjacent strands 12.1/12.2.

FIG. 2 also shows a preferred embodiment of a cable in cross section with the core 21, the outer six wire strands 21.1 . . . 21.6 and two antifreeze elements 23.1, 23.2. As can be seen in the illustration, the antifreeze elements 23.1, 23.2 do not have to be arranged rotationally symmetrical, as in FIG. 1. Each wire strand has e.g. a central wire 21.1 . . . 21.6 and six outer wires 22.1.1 . . . 22.1.6. Instead of the (1+6) structure, a [(1+6)+6(1+6)] structure or another arrangement may also be selected.

FIG. 3 shows a preferred embodiment of a cable in cross section. In addition to the cable shown in FIG. 1, the cable shown in this FIG. 3 has a further layer of wires 34.1 . . . 34.12. Thus, from the inside to the outside, a first layer consisting of six wires 32.1 . . . 32.6, which are arranged as in FIG. 1, first adjoin the core 31. Six antifreeze elements 33.1 . . . 33.6, which are basically positioned analogously, are integrated on the outside of the wires 32.1 . . . 32.6. A second outer layer consisting of twelve evenly arranged wires 34.1 . . . 34.12, which forms the outermost layer of the core, adjoins the first outer layer. The wires 32.1 . . . 32.6 of the first layer are enveloped by the wires 34.1 . . . 34.12 of the second layer in such a manner that spaces are formed between individual wires [32.1, 32.2, 34.2, 34.3], [32.2, 34.4, 32.3, 34.5], [32.3, 34.6, 32.4, 34.7], [32.4, 34.8, 32.5, 34.8], [32.5, 34.10, 32.6, 34.11] and [32.6, 34.12, 32.1, 34.1] in which the antifreeze elements 33.1 . . . 33.6 are integrated.

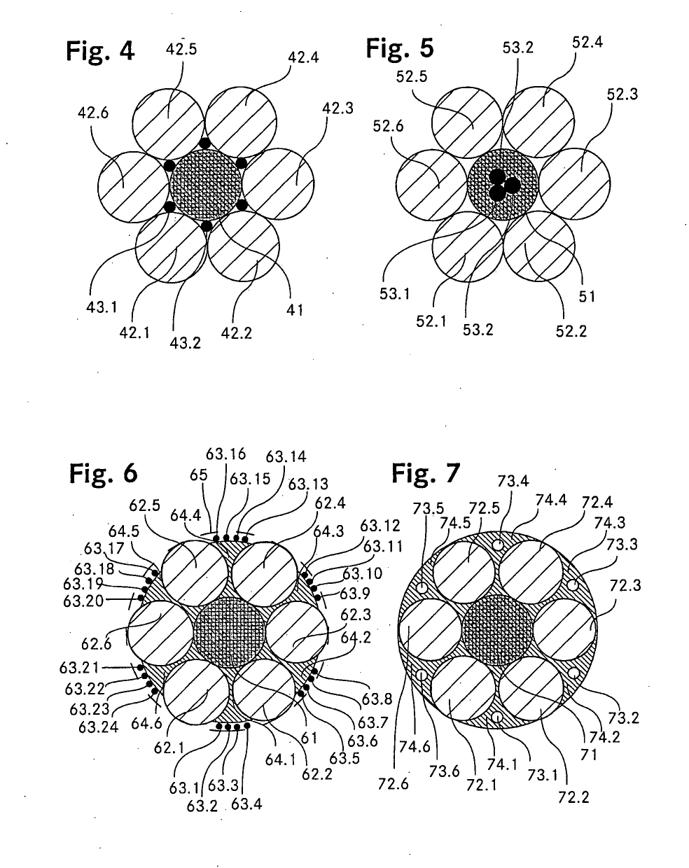

FIG. 4 also shows a further embodiment of a cable according to the invention in cross section. It comprises the core 41, the outer strands 42.1 . . . 42.6 and the six antifreeze elements 43.1 . . . 43.6. Unlike the embodiment shown in FIG. 1, the antifreeze elements 43.1 . . . 43.6 are integrated in the cable between the outer strands 42.1 . . . 42.6 and the core 41. Consequently, both the six antifreeze elements 43.1 . . . 43.6 and the layer of six strands 42.1 . . . 42.6 directly adjoin the core 41 in radial direction. The six antifreeze elements 43.1 . . . 43.6 are distributed uniformly over the periphery of the core 41. They can come in contact with the core 41 and/or the strands 42.6, 42.2, 42.5, 42.1. If the antifreeze element is configured as a heating wire, a direct contact with at least one of the outer strands facilitates the heat transfer to the outside of the cable. The cross section of the antifreeze elements 43.1 . . . 43.6 is advantageously so small that the cable structure (i.e. the arrangement and geometry of core and outer strands) does not have to be altered in comparison to a cable without antifreeze elements. The antifreeze elements can be placed in the geometric spaces between the outer strands 42.1 . . . 42.6 and the core 41 coming into contact, without this having an effect on the radial expansion of the cable.

FIG. 5 shows a further variant of a cable in cross section with the core 41 and six outer strands 52.1 . . . 52.6 uniformly surrounding it. Three antifreeze elements 53.1 . . . 53.3 which are uniformly positioned about the core axis, are integrated in the core 51 of the cable. The core consists e.g. of plastic (e.g. polyethylene) and the antifreeze elements 53.1 . . . 53.3 are integrally cast in the core 51.

The arrangement of the core 51 and the outer strands 52.1 . . . 52.6 can be similar to the embodiment of the cable shown in FIG. 1. The core may also be configured as a steel cable (IWRC).

FIG. 6 shows a further preferred embodiment of a cable in cross section. In addition to the core 61 and the six outer strands 62.1 . . . 62.6 uniformly surrounding it and arranged e.g. as in FIG. 1, the spaces between the respectively adjacent outer strands 62.1/62.2 . . . 62.6/62.1 and the spaces between the outer strands 62.1 . . . 62.6 and the core 61 are filled with plastic inserts 64.1 . . . 64.6. The inserts 64.1 . . . 64.6 extend up to the encasing ring of the cable in the cross sectional view.

Heating wires 63.1 . . . 63.24 are attached to the surface of the inserts 64.1 . . . 64.6 pointing toward the outside. The heating wires 63.1 . . . 63.24 form the antifreeze device and are attached to the surface of the inserts 64.1 . . . 64.6 in this embodiment as wire mesh. In this embodiment, the diameter of the heating wires 63.1 . . . 63.24 is smaller than the diameter of the antifreeze elements shown in the preceding figures. In this embodiment, the outer strands 62.1 . . . 62.6 form the radially outermost points and thus define, depending on the form of a bearing area of a roller travelling on the cable, how greatly the roller approaches the inserts. So that the heating wires 63.1 . . . 63.24 which run on the surface of the inserts 64.1 . . . 64.6 located on the outside of the cable are not damaged or worn by a roller travelling on the cable, the inserts 64.1 . . . 64.6 are not led up to the periphery of the encasing ring 65, but do not exceed, preferably, an (imaginary) demarcation line which is defined by an outer tangent placed on adjacent outer strands.

FIG. 7 shows a similar embodiment as FIG. 6. In addition to the core 71 and the six wire strands 72.1 . . . 72.6 arranged uniformly about the core 71 (only shown schematically), the spaces between the adjacent wire strands 72.1 . . . 72.6 and the core 71 are filled with inserts 74.1 . . . 74.6. However, what is different than in FIG. 6 is that no wire mesh of heating wires is provided on the surface of the inserts 74.1 . . . 74.6. Instead, six lines 73.1 . . . 73.6 are situated as antifreeze dischargers in an area of the inserts 74.1 . . . 74.6 close to the surface. These lines 73.1 . . . 73.6 have openings at the desired points of the cable which open at the outer surface of the inserts. In this way, an antifreeze can be conveyed in the insert and discharged at the point provided with openings.

FIG. 8 shows a further preferred embodiment of a cable in cross section. The embodiment shown in this figure is constructed similar to the embodiment shown in FIG. 2. Six wire bundles, which each comprise a bundle core 81.1 . . . 81.6, are arranged about a core 81. Furthermore, the wire bundle with the bundle core 81.1 comprises five outer wires 82.1.1 . . . 82.1.5 which are arranged directly about the bundle core and an antifreezing device 83.1 which, instead of a sixth wire, extends on the bundle core. The wire bundles about the other bundle cores 81.2 . . . 81.6 are similarly constructed and each comprise an antifreeze element 83.2 . . . 83.6 and five outer wires. As the antifreeze elements 83.1 . . . 83.6 are each integrated in this wire bundle instead of one of the outer wires of a wire bundle, they periodically extend about the bundle core 81.1 . . . 81.6 and are thus situated in sections on the outer surface of the cable or on the core 81 of the cable and in corresponding intermediate positions.

At the end of the suspended cable (e.g. in the mountain or valley station), both the heating wires and the antifreeze lines can be connected to an energy source, in particular a power source, or an antifreeze pump. The energy source or the antifreeze pump, respectively, enable the operation or control of the antifreezing device.

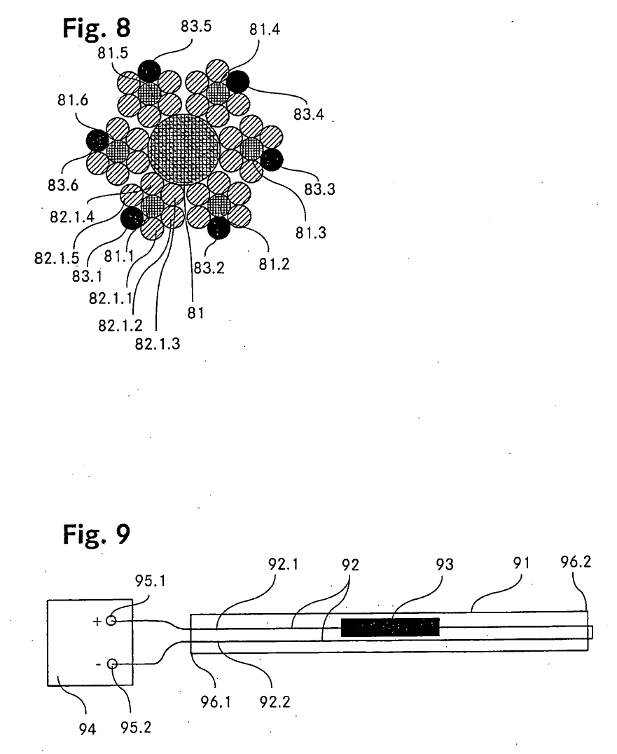

FIG. 9 shows the longitudinal section of a possible embodiment of a cable 91. A line 92, which forms an electric circuit with a power source 94, extends inside the cable 91. The line 92 thereby comprises a resistor which functions as a heating element 93. The heating element 93 forms, together with the line 92, an antifreeze element. The line 92 comprises a first part 92.1 and a second part 92.2. The two parts 92.1 and 92.2 of the line 92 leave the cable 91 at a first end 96.1 and at a second end 96.2 of the cable 91. The first part 92.1 of the line 92 thereby incorporates the heating element 93. In the embodiment of a cable shown in FIG. 9, the first part 92.1 of the line 92 is connected with the second part 92.2 of the line to form a continuous line 92 at the second end 96.2 of the cable 91. At the first end 96.1 of the cable 91, the two parts 92.1 and 92.2 are connected with the contacts 95.1 and 95.2 of the power source 94.

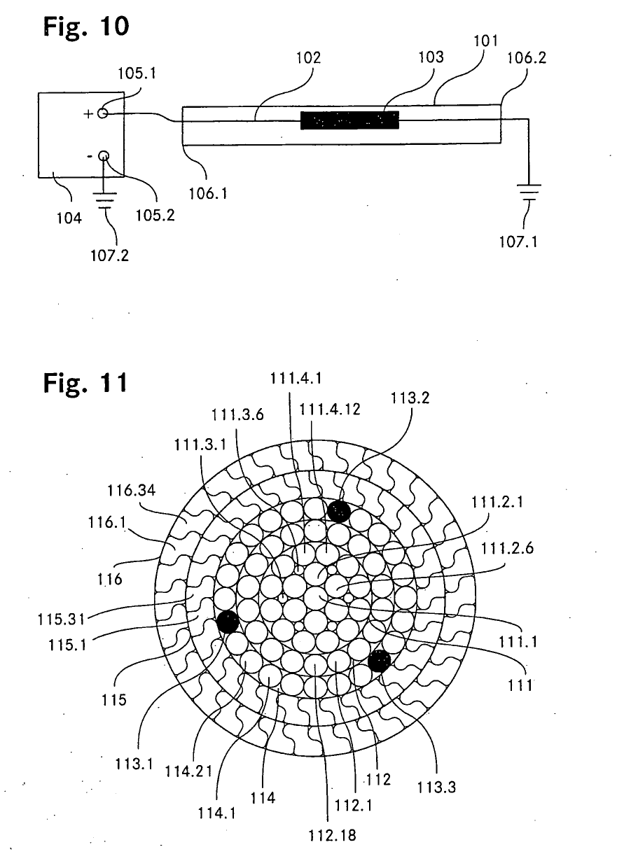

A variant of FIG. 9 is shown in FIG. 10, wherein the heating element 103 is placed in contact with the two ends 106.1, 106.2 of the cable 101. In this case, a line 102 inside the cable 101 comprises a resistor which acts as a heating element 103. The line 102 leaves the cable 101 at both ends 106.1, 106.2. The line 102 is connected to a first contact 105.1 of an electric power source 104 at the first end 106.1 of the cable 102. At the second end 106.2, the line 102 is connected to a first earth mass contact 107.1. The second contact 105.2 of the electric power source 104 is also connected with a second earth mass contact 107.2.

If an electric voltage is applied between the two contacts 105.1, 105.2, a current flows from the first contact 105.1, via the line 102 through the resistor or heating element 103 to the first earth mass contact 107.1 which is electrically connected with the second earth mass contact 107.2. From the second earth mass contact 107.2, the current returns to the power source 104 via the second contact 105.2.

FIG. 11 shows a further cable according to the invention which is laid out, in particular, as a suspension cable for a cable railway. A core 111 is thereby designed as a parallel strand. The core 111 has a central steel wire 111.1 which is circular in cross section and which is surrounded by a total of six steel wires 111.2.1 . . . 111.2.6 having the same diameter, so that they rest on the central steel wire 111.1 and come into contact with two of the respectively adjacent steel wires 111.2.1 . . . 111.2.6. A total of six steel wires 111.3.1 . . . 111.3.6, which are smaller in diameter, are arranged on the outside between two of the steel wires 111.2.1 . . . 111.2.6 each. A further layer with twelve steel wires 111.4.1 . . . 111.4.12 is arranged around them, said steel wires having about the same diameter as the central steel wire 111.1. The steel wires 111.4.1 ... 111.4.12 thereby adjoin both the steel wires 111.2.1 . . . 111.2.6 and the steel wires 111.3.1 . . . 111.3.6 that are smaller in diameter. This arrangement forms the core 111.

A first outer layer 112 consisting of eighteen circular wires 112.1 . . . 112.18 is placed about the core 111, whereby adjacent wires 112.1 . . . 112.18 each come in contact. Outside of the first outer layer 112, a second outer layer 114 is attached which consists of a total of twenty-one circular steel wires 114.1 . . . 114.21. The normal steel wires are replaced by the three antifreeze elements 113.1 . . . 113.3 inside the second outer layer 114. They are uniformly distributed in the layer (i.e. they are arranged at 120° to one another) and consist, for example, of electrically insulated heating wires that are circular in cross section, whereby they have the same diameter as the steel wires 114.1 . . . 114.21 in the second outer layer 114. The steel wires 112.1 . . . 112.18 in the first outer layer 112 and the steel wires 114.1 . . . 114.21 in the second outer layer 114 all have the same diameter as the central steel wire 111.1.

Furthermore, a first layer 115 consisting of 31 profiled wires 115.1 . . . 115.31 with an S-shaped or Z-shaped cross section is arranged outside the second outer layer 114. The individual profiled wires 115.1 . . . 115.31 thereby exhibit complementary outer shapes and adjoin one another without a gap. A second layer 116 consisting of thirty-four somewhat larger profiled wires 116.1 . . . 116.34 is attached as outermost layer, which also have an S-shaped or Z-shaped cross section and adjoin one another without a gap.

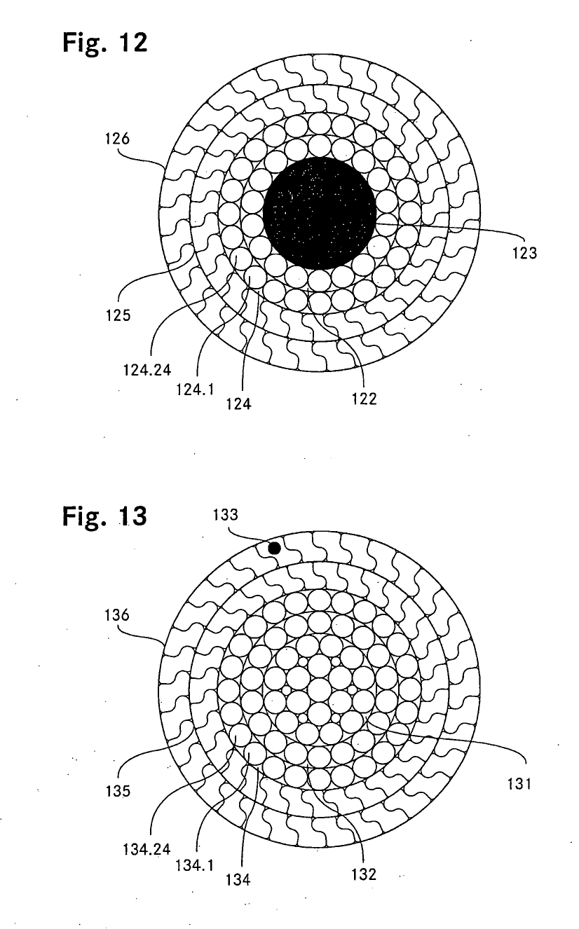

Instead of the core 111 in FIG. 11, the cable in FIG. 12 has a core which is designed as an antifreeze element 123. As in the cable of FIG. 11, a first outer layer 122 consisting of eighteen circular steel wires is found around it. The second outer layer 124 corresponds to the second outer layer of FIG. 11, however, the three antifreeze elements of FIG. 11 are replaced by conventional steel wires in FIG. 12, so that the second outer layer 124 has a total of twenty-four (24) identical steel wires 124.1 . . . 124.24. As the cable in FIG. 11, the cable of FIG. 12 also has two layers 135, 136 consisting of profiled wires with an S-shaped or Z-shaped cross section.

FIG. 13 shows a further variant of a cable according to the invention. It corresponds essentially to the cable of FIG. 11. The structure of the core 131 and the first outer layer 131 is identical to the core 111 and the first outer layer 112 of the cable of FIG. 11. The second outer layer 134 essentially corresponds to the second outer layer of FIG. 11, however, the three antifreeze elements of FIG. 11 are replaced by three conventional steel wires in FIG. 12, so that the second outer layer 124 has a total of twenty-four identical steel wires 124.1 . . . 124.24. The first and the second layer 135, 136 consisting of profiled wires is, in turn, identical to the first and the second layer 115, 116 of the cable of FIG. 11. However, an antifreeze element 133, for example in the form of a heating wire, is attached in one of the profiled wires of the second layer 136.

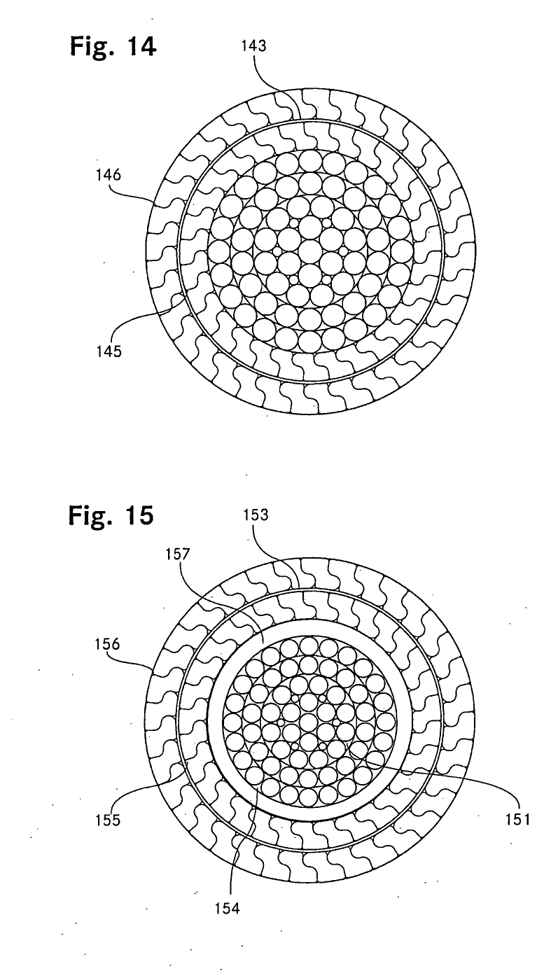

The cable of FIG. 14 is essentially identical to the cable of FIG. 13. However, an antifreeze element 143 in the form of a wire mesh that extends along the entire length of the cable is placed between the first layer 145 of profiled wires and the second layer 146 of profiled wires. It completely surrounds the first layer 145 of profiled wires. Moreover, an antifreeze element in one of the profiled wires is not present.

A further cable, which is essentially identical to the cable of FIG. 14, is shown in FIG. 15. In addition, however, a heat-insulating element 157 is found between the second outer layer 154 of steel wires and the first layer 155 of profiled wires. It is made, for example, of a plastic of a fibrous material and thermally insulates the inner part of the cable from the outer area with the antifreeze element 153 between the two layers 155, 156 of profiled wires. In this way, during de-icing, the heat energy can be specifically concentrated on the outer areas, which reduces energy consumption.

The antifreeze elements can be integrated at various points in the cable. Other arrangements and combinations of the above-described arrangements can also be provided. Thus, for example, it is possible that antifreeze elements are integrated both in an outer strand and in the core. An embodiment of the individual elements of a strand as a core 22.1, as shown in FIG. 2, and outer wires 22.1.1 . . . 22.1.6 can replace the simple design of the cable elements (core, outer strands) in each of the figures. Heating wires or wire meshes can also be integrated in the inserts in another manner (e.g. in a radially extending symmetrical plane of the inserts). Moreover, this is independent thereof if heating wires are provided on the surface of the inserts, or whether heating wires are integrated in the outer strands or other parts of the strands or in the core. A combination of various antifreeze elements may also be used.

It is also within the scope of the invention that the electrical line is tapped at both ends of the cable (if, for example, the ends are close to one another) and connected to a power source. Electrically separate heating elements can also be controlled from both ends.

A wire mesh can also be provided as an areal heating medium between two layers of cable elements. Breaks at certain points in the wire mesh due to radially acting compressive force between wire strands only negligibly affect the function of a heating element of this type.

In FIG. 11, the three antifreeze elements 113.1, 113.2, 113.3 can also be replaced by waveguides for microwaves in the form of rectangular tubes which open in the areas of the cable that consist of microwave-absorbing materials.

The antifreeze element 123 in the core of the cable of FIG. 12 can, for example, also be configured as a fluid-conducting hose or as a tube through which a heated fluid flows.

The antifreeze element 133 of FIG. 13, which is integrated in one of the profiled wires as a heating wire, can also be replaced by an antifreeze element having the outer form of a profiled wire.

In FIG. 13, for example, one or more of the profiled wires of the second layer 136 can also be formed by a sectional strip consisting of a microwave-absorbing material based on silicone, urethane or neoprene. It is also possible to provide a corresponding sectional strip consisting of materials having a high absorption capacity for infrared radiation. In particular, organic polymer compounds, e.g. polyurethanes or polyamides, are suitable as materials for sectional strips of this type.

Instead of an antifreeze element 143 of FIG. 14 which extends in the form of a wire mesh along the entire length of the cable, strip-shaped or ring-shaped sections of wire mesh and/or plate-like areal heating elements can also be provided. These can be attached at regular distances along the entire length of the cable or simply at especially exposed sections of the cable which are subject to heavy ice formation.

Reference is made to the patent U.S. Pat. No. 5,669,214 (Fatzer) concerning the technology of plastic inserts. The invention can also be applied to the cables described there.

Heat-insulating elements, as described in FIG. 15, can also be attached in other positions of the cable which, for example are closer to the core 151 of the cable, if this is appropriate.

In conclusion, it should be noted that a reliable, low maintenance and efficient device was created by the invention for the prevention or specific removal of ice formations on a cable, said cable being especially suitable as a suspension cable for cable railways.

1. A cable, in particular a fixed cable for cable railways, cable structures and/or energy transfer, comprising a core (11) and several outer strands surrounding the core, characterized in that at least one integrated antifreezing device (13.1 . . . 13.6) is provided in the cable which can be activated from one end of the cable or by radiant energy locally coupled in a surface area of the cable.

2. The cable according to claim 1, characterized in that the antifreezing device (13.1 . . . 13.6) comprises an antifreeze element integrated in one of the outer strands.

3. The cable according to claim 1 or 2, characterized in that the antifreezing device (53.1 . . . 53.3) comprises an antifreeze element integrated in the core (51).

4. The cable according to any one of the claims 1 to 3, characterized in that it has inserts (74.1 . . . 74.6) between the outer strands (72.1 . . . 72.6) and that an antifreeze element (73.1 . . . 73.6) is integrated in one of the inserts (74.1 . . . 74.6).

5. The cable according to any one of the claims 1 to 4, characterized in that the antifreeze element (63.1 . . . 63.24) is configured as electrical resistance heating.

6. The cable according to claim 5, characterized in that the antifreeze element (63.1 . . . 63.24) comprises a heatable wire mesh as resistance heating.

7. The cable according to any one of the claims 4 to 6, characterized in that the inserts (64.1 . . . 64.6) have sections of varying heat conductivity.

8. The cable according to any one of the claims 5 to 7, characterized in that the antifreeze element (63.1 . . . 63.24) has sections of various electrical resistance.

9. The cable according to any one of the claims 1 to 4, characterized in that the antifreeze element (13.1 . . . 13.6) is configured as an antifreeze discharging device.

10. The cable according to any one of the claims 1 to 9, characterized in that the antifreeze element (13.1 . . . 13.6) is only provided in selected sections of the cable.

11. The cable according to any one of the claims 1 to 10, characterized in that a heat-insulating element (157) is provided which divides the cable into an inner and an outer area, in particular in radial direction.

12. The cable according to claim 11, characterized in that the antifreezing device is arranged in the outer area, outside of the heat-insulating element (157).

13. The cable according to any one of the claims 1 to 12, characterized in that a wire layer, in particular of aluminum, is integrated as antifreeze element, said layer being inductively heatable.

14. The cable according to any one of the claims 1 to 13, characterized in that a microwave-absorbing material, in particular based on silicone, urethane or neoprene, is integrated as antifreeze element.

15. The cable according to any one of the claims 1 to 14, characterized in that a material having a high absorption capacity for infrared radiation, preferably organic polymer compounds and in particular polyurethanes or polyamides, is integrated as antifreeze element.
